(19) United States
(12) Patent Application Publication
(10) Pub. No.: US 2026/0018736 A1
(43) Pub. Date: Jan. 15, 2026

(54) Pressure equalization device

(71) Applicant: Bodo Konzelmann KG, Löchgau (DE)

(72) Inventors: Milko Konzelmann, Bieitigheim-Bissingen (DE); André Konzelmann, Bieitigheim-Bissingen (DE)

(21) Appl. No.: 18/997,857

(22) PCT Filed: Jun. 26, 2023
(86) PCT No.: PCT/EP2023/067270

§ 371 Date: Jan. 23, 2025

(30) Foreign Application Priority Data
Jul. 29, 2022 (DE) 10 2022 119 107.9

(51) Int. Cl. H01M 50/342; H01M 50/152; H01M 50/30

(52) U.S. Cl. CPC H01M 50/3425; H01M 50/152; H01M 50/394

(57) ABSTRACT

The invention relates to a pressure equalization device (20) for equalizing an internal pressure in a receiving housing of an electrochemical or electrotechnical device, in particular a battery housing, having a housing (20.3) that has at least one gas passage opening (20.4), which forms a gas-permeable connection between an interior (20.1) and an exterior (20.2) of the housing (20.3), wherein the gas passage opening (20.4) is blocked by means of a gas-permeable or gas-tight diaphragm (40), wherein the diaphragm (40) is assigned a burst element (30), which is designed and positioned such that, when the diaphragm (40) is deformed in the direction of the exterior (20.2), the diaphragm is destroyed at least at one point under the action of the burst element (30) to establish a flow connection from the interior (20.1) to the exterior (20.2) through the gas passage opening (20.4). In order to be able to achieve a reproducible bursting behavior in such a pressure equalization device by simple means, according to the invention provision is made for the diaphragm (40), its inner face (42) facing the interior (20.1) of the housing (20.3), to be connected, in particular by a material bond, to the burst element (30).

The invention relates to a pressure equalization device for equalizing an internal pressure in a receiving housing of an electrochemical or electrotechnical device, in particular for a battery housing, having a housing that has at least one gas passage opening, which forms a gas-permeable connection between an interior and an exterior of the housing, wherein the gas passage opening is blocked, in particular at least partially covered, by means of a gas-permeable or gas-tight diaphragm, wherein the diaphragm is assigned a burst element, which is designed and positioned such that, when the diaphragm is deformed in the direction of the exterior, the diaphragm is destroyed at least at one point under the action of the burst element to establish a flow connection from the interior to the exterior through the gas passage opening.

Such pressure equalization devices according to the invention are used to equalize the internal pressure in a receiving housing. During normal operation, the diaphragm can be used to equalize certain pressure fluctuations between the interior of the receiving housing and the environment if the diaphragm is designed to be gas-permeable. If a non-gas-permeable diaphragm is used, additional measures must or can be provided to compensate for normal pressure fluctuations.

If the internal pressure in the interior of the receiving housing, towards which the interior of the pressure equalization device is facing, rises suddenly, this pressure has to be relieved immediately to prevent the receiving housing from bursting. For this purpose, a burst element is provided in the pressure equalization devices according to the invention, which burst element then destroys the diaphragm at at least one point. In pressure equalization devices according to the invention, this can be achieved by deforming the diaphragm to such an extent that it is destroyed at the burst element, for instance by being cut into. The internal pressure of the receiving housing can then be relieved via the released area through the gas passage opening towards the exterior of the pressure equalization device and thus towards the environment.

A pressure equalization device is known from DE 10 2011 080 325 A1. This known pressure equalization device features a housing having a flange section with drilled holes for attachment to a battery housing. In so doing, the housing covers the rim of an aperture in the battery housing. The housing is connected to a diaphragm that blocks a gas passage opening of the housing. The diaphragm is stretched between the support element and a clamping piece and is held in a circumferentially sealed manner. Further, a housing-like protective element is used, which comprises a cutting element in a central area. This cutting element is opposite from the diaphragm. The protective element is used to prevent access to the diaphragm from the exterior of the pressure equalization device. The protective element has gas passage openings. The diaphragm is gas permeable but essentially water repellent. The water-repellent function is such that water from the environment cannot reach the interior from the exterior, or only to an insignificant extent. During normal operation, the diaphragm can provide the gas equalization between the environment and the battery housing. This is possible because the diaphragm is permeable to gas. If an abrupt burst pressure now occurs, for instance due to a fault in the battery housing, the diaphragm bulges outward. A distance is provided between the cutting element and the outer face of the diaphragm, which determines the permissible deformation of the diaphragm in such a damage event. If the diaphragm bulges beyond the permissible deformation, it hits the cutting element, which is designed as a tip. The cutting element damages the diaphragm, causing it to rupture. The gas can then quickly escape from the battery housing through the gas passage opening into the environment. This prevents the battery case from exploding.

The pressure equalization device known from the prior art has a complex design. In addition, owing to the inevitable dimensional tolerances that occur between the individual components of the device same design, it cannot be ensured that the cutting element is always at exactly the same distance from the surface of the diaphragm in different emergency degassing devices of the same type. Therefore, there is no exactly reproducible bursting behavior in case of overload.

The invention addresses the problem of providing a pressure compensation device of the type mentioned at the beginning, reliably ensuring a reproducible bursting behavior.

This problem is solved by the diaphragm, its inner face facing the interior of the housing, being connected to the burst element, in particular by a material bond (adhesive and/or cohesive bond).

If, in the event of an overload, there is an impermissible increase in pressure in the receiving chamber of the receiving housing and thus on the inner face of the diaphragm, the diaphragm bulges towards the exterior of the housing. As the inner face of the diaphragm is attached to the burst element, the diaphragm cannot deform there or cannot deform there to the same extent as in the rest of the area covering the gas passage opening. As a result, the diaphragm ruptures in the area of the burst element because of these unequal deformation states, opening the gas passage opening. The pressure can then be released from the receiving housing towards the exterior.

In this way, reproducible bursting behavior is guaranteed, as the diaphragm is directly connected to the burst element instead of a tolerance-dependent distance having to be set between a cutting tip and the outer face of the diaphragm, as is the case with the prior art. Surprisingly, it has been shown that the bursting behavior of the diaphragm is significantly improved when the inner face of the diaphragm is coupled to the burst element. In particular, the response behavior in the event of an impermissible increase in pressure is improved.

According to the invention, the burst element can form a body edge at the connection with the diaphragm, where the diaphragm tears off or is cut off due to the pressure differences acting between the inner face and the outer face of the housing. As soon as a tear or a cut is initiated in the diaphragm, it is weakened to such an extent that it ruptures and abruptly opens the gas passage opening.

Advantageously, the burst element is arranged such that it protrudes into the area of the gas passage opening and the connection with the diaphragm, in particular the positive connection, is arranged at least sectionally in the protruding part. Tearing initiation can then occur on the burst element in a diaphragm area that is subject to great deformation. In addition, the burst element on the inner face of the diaphragm supports the diaphragm against external pressure. Such a pressure effect can occur, for instance, if water pressure is applied from the outside by a cleaning device (hose, steam jet). This support reduces the risk of unintentional damage to the diaphragm in such an operating position.

A preferred embodiment of the invention can be such that the diaphragm has a circumferential rim by means of which it is connected circumferentially to the housing, that the burst element projects into the area of the gas passage opening, and is connected to the diaphragm in an area inside the circumferential rim, in particular connected by a material bond.

It is particularly preferable for the connection to extend in a central area or at least sectionally into the central area of the diaphragm.

A possible variant of the invention is such that a surface area of the diaphragm covers the gas passage opening, wherein this surface area has a maximum free covering length, and that the length of the burst element extending into the area of the gas passage opening is at least 30% of this free covering length, and/or that the minimum longitudinal extent of the material bond in one direction is at least 25% of this free covering length. In this way, a good internal support for the diaphragm and in addition, a good bursting behavior is achieved.

A possible variant of the invention can also be such that the gas passage opening is delimited by an annular circumferential wall and that the burst element projects radially inwards from the wall into the area of the gas passage opening.

According to a preferred embodiment variant of the invention, provision may be made for the burst element to have a connecting section having a connecting surface facing the diaphragm, to which the diaphragm is attached by a material bond, that the connecting surface merges into a rim, in particular into an edge, preferably a cutting edge, extending transversely to the connecting surface, and that preferably the material bond extends as far as the rim, in particular to the edge, preferably to the cutting edge. This measure further improves the reproducible bursting behavior, as a defined positioning for tearing initiation is provided at the rim, in particular at the edge, in particular at the cutting edge.

If provision is made for the housing to have a cover section having a circumferential mount, which is preferably designed as an indentation and which encompasses the gas passage opening, and for the circumferential rim of the diaphragm to be attached to the mount or inserted into the mount and for a connecting area of the circumferential rim to be connected to a connecting section of the mount by a circumferential material bond, then a precise positioning of the diaphragm is achieved in a simple manner.

In particular, provision may also be made for the diaphragm to be back-injected with the housing in a plastic-injection-molding process. In so doing, the connection and sealing of the diaphragm, the housing and the burst element are integrated into the injection molding process accordingly. However, within the scope of the invention, it is also possible for the diaphragm to be joined to a manufactured housing, in particular to be joined by a material bond.

It is particularly advantageous if provision is made for the connecting section of the burst element, to which the diaphragm is connected by a material bond, to merge flush with the connecting section. The connections between the burst element and the diaphragm and the housing and the burst element can then be manufactured in one process step.

According to a variant of the invention, provision may be made for the housing to bear a spacer in the area of its exterior, which bears a cover at a distance from the diaphragm, which cover covers the diaphragm at a distance from the outer face of the diaphragm using a cover section, then the outer face of the diaphragm is protected from mechanical stress.

Advantageously, provision may also be made for the spacer to have at least one ventilation opening that establishes a spatial connection between the outer face of the diaphragm and the environment. Pressure can be equalized with the environment via the ventilation opening. If the diaphragm is gas-permeable, for instance, pressure can be equalized between the interior and the exterior via the diaphragm and the ventilation opening during normal operation (breathing function).

If provision is made for the spacer to be designed at least sectionally as an annular body or to have such an annular body, for the annular body to have an outer wall, which is at a distance from a rim of the cover, and for at least one venting area in the form of a spacer space to be formed between the rim and the outer wall, then mechanical access protection can be easily implemented.

For a simple fastening of the cover section, provision may be made for the spacer to have a fastening attachment with a retaining part in an area above the outer face of the diaphragm and at a distance therefrom, for the cover section to be fastened to the retaining part using the spacer, and for the cover section to be of from a flexible material. In the event of a burst, the pressure in the gas flow deforms the cover section. This allows a large opening cross-section that was previously covered by the cover section to be opened suddenly.

This results in a simple, compact design if the spacer has bars that hold the fastening attachment over the outer face of the diaphragm and that gas routing areas are formed between the bars.

The problem of the invention is also solved by a method for equalizing an internal pressure in a receiving housing of an electrochemical or electrotechnical device, in particular in a battery housing, having a pressure equalizing device according to any of claims 1 to 12, wherein, in the event of an impermissible pressure increase in the receiving housing, the diaphragm is deformed, in particular bulged, in the direction of the exterior facing away from the interior of the receiving housing, and wherein the diaphragm is destroyed at least at one point under the action of the burst element to establish a flow connection from the interior to the exterior through the gas passage opening.

In the context of the invention, the diaphragm can be designed to be watertight or largely watertight; the diaphragm can in particular be designed as a sheet element, in particular as a plastic film. A polyester material used for the diaphragm, may for instance comprise a polyethylene terephthalate or a polycarbonate, or it may be made entirely of such a material.

The diaphragm is preferably shaped like a circular disc. This results in advantageous properties when the diaphragm is deformed.

The invention is explained in greater detail below based on exemplary embodiments shown in the drawings. In the figures,

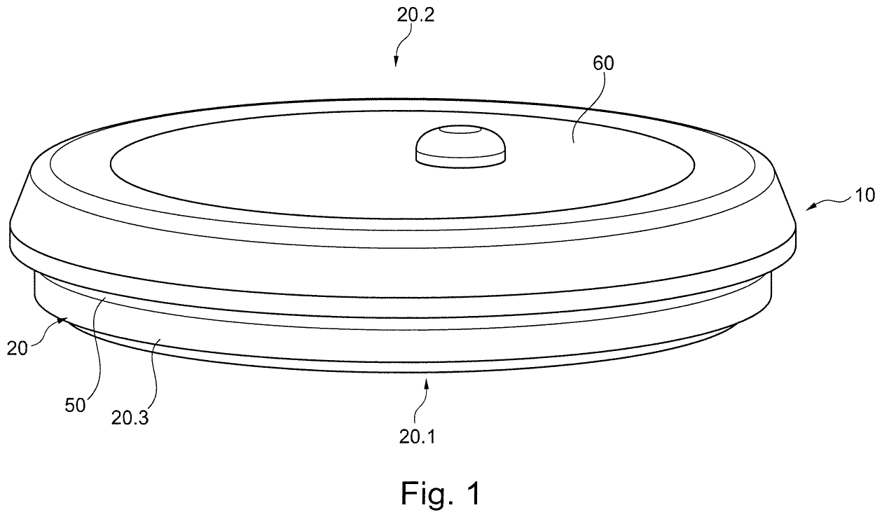

FIG. 1 shows a perspective view of a protective device 10 from above,

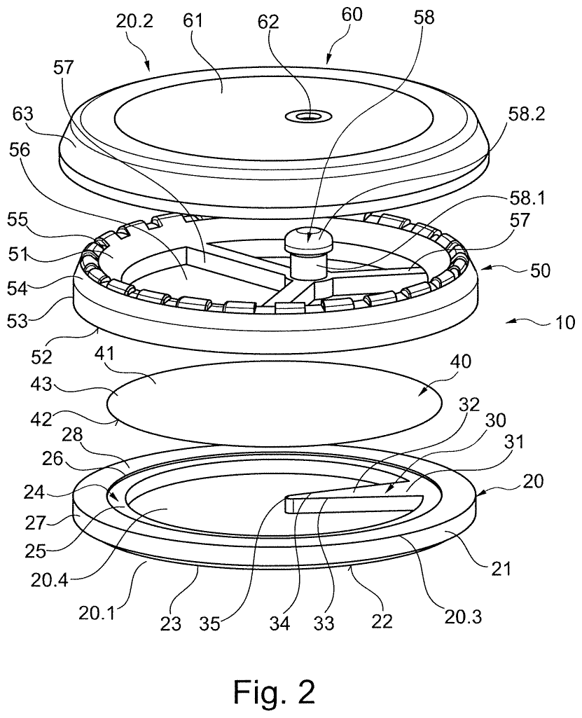

FIG. 2 shows an exploded view of the protective device 10 of FIG. 1,

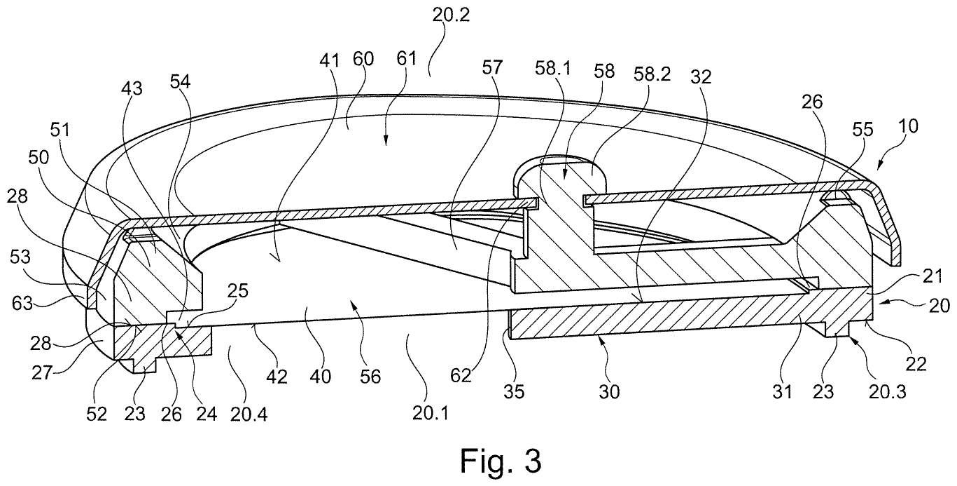

FIG. 3 shows a full section of the protective device 10 of FIG. 1,

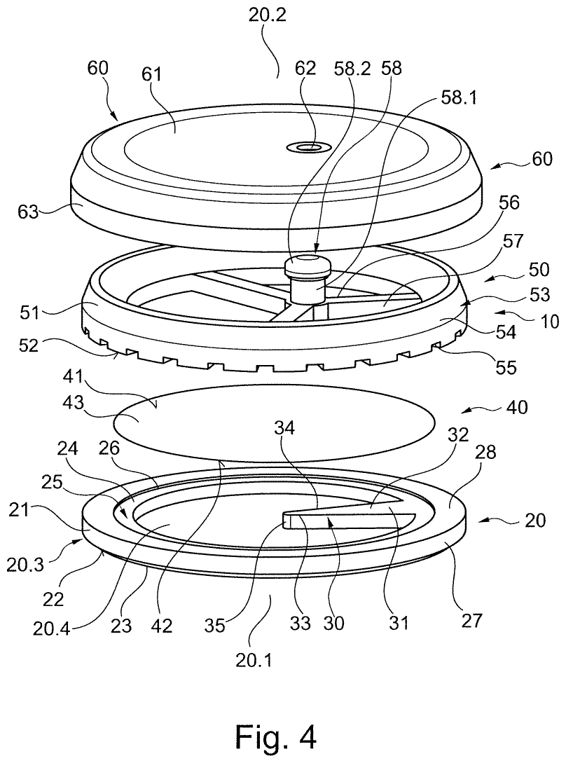

FIG. 4 shows a perspective view of a further protective device 10 according to the invention and

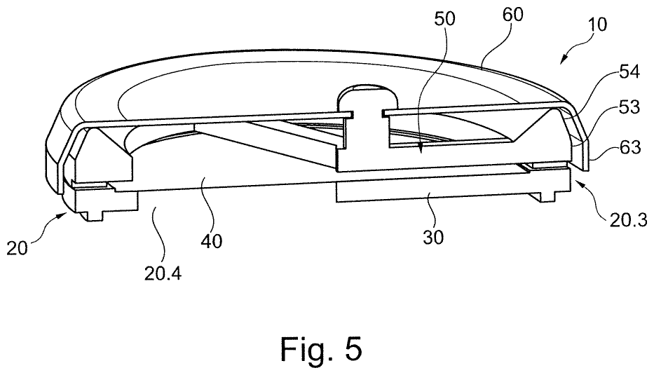

FIG. 5 shows a full section of the representation of FIG. 4.

FIG. 1 shows a perspective view of a protective device 10 having a pressure equalization device 20. This pressure equalization device 20 has a housing 20.3. The housing 20.3 forms an exterior 20.2 and an interior 20.1.

When the housing 20.3 is operationally assembled with a receiving housing, in particular an electrochemical or electrical device, for instance an accumulator housing, the interior 20.1 is assigned to the interior of the receiving housing. The exterior 20.2, on the other hand, is assigned to the interior of the receiving housing facing away from the environment.

As FIGS. 2 and 3 show, the housing 20.3 forms a cover 21 in the area of the exterior 20.2. At the top, the cover is closed by a cover section 28, which forms a cover surface. Opposite from the cover section 28, the housing 20.3 has a sealing section at the cover 21.

The sealing section may be formed as an annular circumferential projection on the housing 20.3, and preferably projects radially beyond an exterior of the housing 20.3.

The sealing section, facing the interior 20.1, forms a mounting surface. Preferably, this mounting surface is formed as an annular circumferentially closed surface, which further preferably extends in the radial direction. A seal can be provided circumferentially in the area of the mounting surface, which seal is molded onto the area of the sealing section using a 2-component injection molding process, for instance, and projects in the direction of the interior 20.1.

In addition or as an alternative to the seal, an energy director can also be provided protruding from the mounting surface. The energy director can be designed as circumferential bulge. It can be used to weld the housing 20.3 tightly to the receiving housing all the way around.

As FIG. 2 shows, the housing 20.3 can have a mount 24, to which the circumferential rim of a diaphragm 40 is attached, preferably attached by a material bond. Advantageously, the diaphragm 40 is designed in the form of a circular disk, such that the rim of this circular disk forms a connecting area 43, which can be used to circumferentially attach the diaphragm 40 to the mount 24.

Preferably, the mount 24 is in the form of an indentation 26, which is sunken into the top of the cover section 28. The indentation 26 thus forms a circumferential connecting section 25 for the circumferential rim of the diaphragm 40.

The top surface 28 of the housing 20.3 merges into an outer wall 27 of the cover 21.

The housing 20.3 can form a circumferential inner panel which encompasses a gas passage opening 20.4. The diaphragm 40 can be used to close the gas passage opening 20.4. The diaphragm 40 is designed as a sheet element and is preferably made of a gas-permeable or gas-tight plastic film. The diaphragm 40 is formed to be substantially watertight and is preferably tear resistant to a sufficient degree to prevent the accidental failure of the diaphragm 40 by exposure to water pressure from the exterior 20.2.

The diaphragm 40 has an outer face of the diaphragm 41 facing the exterior 20.2 of the housing 20.3. Opposite from the outer face of the diaphragm 41, the diaphragm 40 has an inner face of the diaphragm 42, which faces the interior 20.1. of the housing 20.3.

As FIG. 2 shows, the diaphragm 40 comprises the circumferential connection area 43, which can be in particular annular. This connection area 43 is used to connect the diaphragm 40 to the connection section 25 of the mount 24 in a gas-tight manner, preferably by a material bond. In particular, the diaphragm 40 may be back-injected with the housing 20.3 using a plastic injection molding process.

The connection section 25 is formed as an annular circumferential surface on the mount 24. In particular, the connection section 25 extends around the gas passage opening 20.4 in an annular shape.

FIGS. 1 and 2 also show that a burst element 30 is formed on the housing 20.3, which burst element can have a cutting element as in this case. Preferably, the burst element 30 is integrally connected to the housing 20.3. Particularly preferably, the burst element 30 is integrally connected to the inner panel of the housing 20.3.

As the drawings show, the burst element 30 is connected to the housing 20.3 via a coupling section 31, which can also be designed as a spring section. Furthermore, the entire burst element 30 can also additionally be spring-elastic or form the spring section.

At its free end, the burst element 30 has an end section 34, which forms an edge, preferably a cutting edge 34, on its end facing the exterior 20.2, as FIG. 2 shows.

Additionally or alternatively, provision may also be made for one or more rims of the burst element 30 to be formed having a rim or an edge, preferably a cutting edge 33, 34.

The above-mentioned cutting edges 33, 34 can be point-shaped, linear, curved or formed in any other way.

In this exemplary embodiment, the burst element 30 is coupled to the housing 20.3, preferably integrally connected via the coupling piece 31. Starting from the coupling piece 31, the burst element 30 protrudes into the area that forms the gas passage opening 20.4.

Starting from the coupling piece 31, the burst element 30 tapers continuously in the direction of the end section 35. The cutting edges 33, 34 can converge from the coupling piece 31 in the direction of the end section 35 and extend in a linear manner.

As FIG. 2 shows, the connecting section 32 of the burst element 30 merges flush with the surface of the connecting section 25. In this way, a continuous material bond can be created between the diaphragm 40 at its circumferential connecting section 43 and at the same time at the connecting section 32. However, this is not mandatory. In particular, the connecting section 32 may be arranged at a distance from the mount 24.

As FIG. 3 shows, the burst element 30 protrudes into the center area of the diaphragm 40 and thus supports it there in the area of the inner face of the diaphragm 42.

FIGS. 2 and 3 further illustrate that the housing 20.3 of the pressure compensation device 20 can have a centering attachment 23 adjacent to the fastening section 22. This centering attachment 23 is designed in the form of a circumferential ridge, as shown in FIG. 3. The centering attachment 23 can be used to align the housing 20.3 in an opening in the receiving housing to which the pressure compensation device 20 can be attached.

FIGS. 2 and 3 further show that a spacer 50 can be connected to the housing 20.3. The spacer 50 can be designed as an annular body.

FIG. 2 shows that the spacer 50 has an underside 52, by means of which it can be placed on the cover section 28 and connected thereto, preferably by a material bond. Subsequent to the underside 52, the spacer 50 has a neck 51 protruding upwards towards the exterior 20.2. At its upper end, the neck 51 is provided with several ventilation openings 55 in the form of recesses.

The spacer 50 encompasses a gas routing area 56, which is formed above the outer face of the diaphragm 41.

Bars 57 are integrally formed on the neck 51. In this exemplary embodiment, three bars 57 are used, which are interconnected in the area of the center of the gas routing area 56 and which can be arranged offset by 120° relative to one another. A fastening attachment 58 is provided in the area where the bars 57 are merged. The fastening attachment 58 projects upwards from the bars 57 towards the exterior 20.2 and has a retaining part 58.1, which ends with a head 58.2.

A cover 60 can be connected to the spacer 50. The cover 60 has a cover section 61, into which a fastening mount 62 is integrated. Furthermore, the cover section 61 has a circumferential rim 63.

To mount the cover 60, it is connected to the spacer 50. This is achieved in a simple manner by connecting the cover section 61 to the fastening attachment 58.

In particular, the cover 60 may be made of a flexible material, such as a rubber-like material. The cover section 61 can then be stretched in the area of the fastening mount 62 and guided over the head 58.2 such that it then appends to the retaining part 58.1.

FIG. 3 shows that the cover section 61 of the cover 60 rests on the end of the neck 51 in the assembled state. As the ventilation openings 55 are set back in relation to the free end of the neck 51, a gas-conveying connection can be established between the outer face of the diaphragm 41 and the environment.

FIG. 3 further shows that for this gas-conveying connection, the circumferential rim 63 of the cover 60 is also spaced apart from an outer wall 53 of the neck 51, wherein the outer wall 53 is of annular circumferential design.

When the pressure equalization device 20 is mounted on a receiving housing (not shown), the interior 20.1 of the housing 20.3 and thus also the inner face 42 of the diaphragm are assigned to the interior of the receiving housing. The exterior 20.2 and thus also the outer face of the diaphragm 41 of the diaphragm 40 are assigned to the environment.

If the diaphragm 40 is designed as a gas-permeable diaphragm 40, pressure differences between the environment and the interior of the receiving housing can be equalized via the diaphragm 40 during normal operation to implement a breathing function.

This pressure equalization is conducted in such a way that, for instance, when the pressure in the interior of the receiving housing increases compared to the environment, gas passes through the gas-permeable diaphragm 40 into the gas routing area 56 of the spacer 50. From there, this gas is discharged into the environment via the ventilation openings 55. Pressure equalization in the opposite direction can also take place in the event of a pressure drop inside the receiving housing.

If the pressure in the receiving housing rises suddenly, this pressure is present on the inner face of the diaphragm 42. The diaphragm 40 is thereby deformed in the direction of the exterior 20.2, in particular it bulges in the direction of the exterior 20.2. During this stage, different deformation states occur on the diaphragm 40. Where the inner face 42 of the diaphragm is connected to the facing connecting section 32 of the burst element 30, in particular where it is connected by a material bond, the diaphragm 40 is not deformed or is deformed to a lesser extent than in the surrounding area covering the gas passage opening 20.4. Owing to these different deformation states, the diaphragm 40 is separated in the area of the connecting section 32 of the burst element 30. In particular, a tearing of the diaphragm 40 is initiated at at least one of the cutting edges 33, 34 of the end section 35 described above and/or of the connecting section 32 due to the existing pressure differences.

In this way, the diaphragm 40 is damaged and subsequently destroyed. As a consequence, the area of the gas passage opening 20.4 suddenly opens, at least sectionally. The released gas flow reaches the cover 60. If the gas flow is so strong that it cannot be discharged via the ventilation openings 55, the flexible cover section 61 bends outwards and a larger cross-section is suddenly released for discharging the gas flow.

FIGS. 4 and 5 show a further exemplary embodiment of the invention. As this diagram illustrates, the ventilation openings 55 are formed in the area between the underside 52 of the spacer 50 and the cover section 28 of the housing 20.3. Otherwise, the exemplary embodiment according to FIGS. 4 and 5 equals the exemplary embodiment according to FIGS. 1 to 3. Thus, reference can be made to the above statements to avoid repetitions.

1-13. (canceled)

14. A pressure equalization device for equalizing an internal pressure in a receiving housing of an electrochemical or electrotechnical device, the pressure equalization device comprising:
a device housing including at least one gas passage opening between an interior and an exterior of the device housing;
a diaphragm blocking the at least one gas passage opening, the diaphragm having an inner face facing the interior; and
a burst element configured such that when the diaphragm is deformed in a direction of the exterior the diaphragm is destroyed at at least one point by the burst element to establish a flow connection from the interior to the exterior through the at least one gas passage opening, the burst element being connected to the inner face of the diaphragm.

15. The pressure equalization device of claim 14, wherein:
the burst element is connected to the inner face of the diaphragm by a material bond.

16. The pressure equalization device of claim 14, wherein:
the burst element includes a connecting section having a connecting surface facing the diaphragm, the diaphragm being attached to the connecting surface by a material bond, the connecting surface merging into a rim.

17. The pressure equalization device of claim 16, wherein:
the rim includes an edge.

18. The pressure equalization device of claim 17, wherein:
the edge is a cutting edge.

19. The pressure equalization device of claim 16, wherein:
the material bond extends as far as the rim.

20. The pressure equalization device of claim 14, wherein:
the diaphragm includes a circumferential rim connected circumferentially to the device housing; and
the burst element projects into the at least one gas passage opening and the burst element is connected to the diaphragm in an area inside the circumferential rim of the diaphragm.

21. The pressure equalization device of claim 20, wherein:
the burst element is connected to the diaphragm by a material bond.

22. The pressure equalization device of claim 21, wherein:
the diaphragm includes a surface area covering the at least one gas passage opening, the surface area having a maximum free covering length; and
the burst element projects into the at least one gas passage opening by a length at least 30% of the maximum free covering length.

23. The pressure equalization device of claim 21, wherein:
the diaphragm includes a surface area covering the at least one gas passage opening, the surface area having a maximum free covering length; and
a longitudinal extent of the material bond between the burst element and the diaphragm in one direction is at least 25% of the maximum free covering length.

24. The pressure equalization device of claim 14, wherein:
the device housing includes an annular circumferential wall delimiting the at least one gas passage opening; and
the burst element projects radially inwards from the wall into the at least one gas passage opening.

25. The pressure equalization device of claim 14, wherein:
the device housing includes a cover section including a circumferential mount, the circumferential mount surrounding the at least one gas passage opening; and
the diaphragm includes a circumferential rim connected to the circumferential mount by a circumferential material bond.

26. The pressure equalization device of claim 25, wherein:
the burst element includes a connecting section merging flush with the circumferential mount.

27. The pressure equalization device of claim 14, further comprising:
a spacer supported from the device housing; and
a cover carried by the spacer such that the cover covers the diaphragm with a cover section at a distance from an outer face of the diaphragm.

28. The pressure equalization device of claim 27, wherein:
the spacer includes at least one ventilation opening establishing a spatial connection between the outer face of the diaphragm and an environment outside of the device housing.

29. The pressure equalization device of claim 27, wherein:
the spacer includes an annular body having an outer wall spaced a distance from a rim of the cover, such that at least one venting area is formed as a spacing between the outer wall of the annular body and the rim of the cover.

30. The pressure equalization device of claim 27, wherein:
the spacer includes a fastening attachment including a retaining part located at a distance from the outer face of the diaphragm; and
the cover section is formed of a flexible material and is fastened to the retaining part.

31. The pressure equalization device of claim 30, wherein:
the spacer includes a plurality of bars holding the fastening attachment over the outer face of the diaphragm, and the spacer includes gas routing areas between the bars.

32. A method of equalizing an internal pressure in the receiving housing of the electrochemical or electrotechnical device using the pressure equalization device of claim 14, the method comprising:
in an event of an impermissible pressure increase in the receiving housing, deforming the diaphragm in the direction of the exterior facing away from the interior of the receiving housing; and
destroying the diaphragm at the at least one point by action of the burst element thereby establishing the flow connection from the interior to the exterior through the at least one gas passage opening.

33. The method of claim 32, wherein:
the deforming includes bulging the diaphragm.
